(19) United States
(12) Patent Application Publication
(10) Pub. No.: US 2016/0224202 A1
(43) Pub. Date: Aug. 4, 2016

(54) SYSTEM, METHOD AND USER INTERFACE FOR GESTURE-BASED SCHEDULING OF COMPUTER TASKS

(71) Applicant: YANDEX EUROPE AG, Luzern (CH)

(72) Inventor: Ivan Sergeevich MOSKALEV, Moscow (RU)

(21) Appl. No.: 14/917,319

(22) PCT Filed: Nov. 25, 2013
(86) PCT No.: PCT/RU2013/001060

§ 371 Date: Mar. 8, 2016

(51) Int. Cl. G06F 3/0481; G06Q 10/10; G06F 3/0354; G06F 3/0484; G06F 3/0488

(52) U.S. Cl. CPC G06F 3/04812; G06F 3/04842; G06F 3/04883; G06F 3/03543; G06F 3/04847; G06Q 10/1097

(57) ABSTRACT

Disclosed are systems, methods, computer program products, and graphical user interfaces for gesture-based scheduling execution of computer tasks. In one aspect of the invention, a system for scheduling execution of computer tasks detects a user's selection of a user interface (UI) element on a display of a user device and captures a user's gesture following the selection of the UI element. The system then recognizes the captured gesture as an indication of scheduling of a delayed execution of a computer task associated with the selected UI element and calculates a time delay for execution of the computer task based on the captured gesture. The system then schedules a delayed execution of the computer task associated with the selected UI element based on the calculated time delay.

### TECHNICAL FIELD

The disclosure relates generally to the field of human-machine interaction, and more specifically to systems, methods and user interfaces for gesture-based scheduling of computer tasks.

### BACKGROUND

The growth in popularity of computer devices, such as personal computers (PC), notebooks, tablets, smart phones, etc., have been driven in part by the development of sophisticated user interface (UI) devices that allow easy and intuitive human-machine interaction. Historically popular keyboard and mouse data input devices are being replaced more and more by touch-screen-based data input devices on the latest generation of PCs, tablets, notebooks and smart phones. In fact, a new generation of operating systems (OS), such Windows® 8, Android® OS, iOS®, have been designed to support touch- and gesture-based interaction as primary means of UI, while retaining legacy support of keyboard and mouse.

Generally, graphical UI (GUI) of a computer OS and computer programs is designed to simplify performance of common tasks by minimizing the number of keyboard commands, number of mouse clicks or number of finger touches necessary to perform a certain task. For example, some common computer tasks, such as copying and pasting text, sending an e-mail, opening a browser window, can be performed with just one or two actions. However, heretofore, there was no simple way for a user to perform program scheduling tasks, such as delaying transmission of an e-mail or instructing a Web browser to open a webpage at certain time. Therefore, there is a need for a simple mechanism for scheduling of computer tasks.

### SUMMARY

Disclosed are systems, methods, computer program products, and user interfaces for gesture-based scheduling execution of computer tasks. In one example aspect, a task scheduling system may detect a user's selection of a user interface (UI) element on a display of a user device and captures a user's gesture following the selection of the UI element. The system may then recognize the captured gesture as an indication of scheduling of a delayed execution of a computer task associated with the selected UI element and may also calculate a time delay for execution of the computer task based on the captured user's gesture. The system may then schedule a delayed execution of the computer task associated with the selected UI element based on the calculated time delay.

The task scheduling system may also generate a scheduling UI overlay that graphically indicates a duration of the time delay. For example, the scheduling UI overlay may include a straight prolongation bar, a time line or an analog clock. The system may also modify the scheduling UI overlay in real-time with capturing of the user's gesture to graphically indicate the duration of the time delay set by the user.

The system may detect a user's selection of the UI element by detecting positioning of a cursor over the UI element and a right-click or left-click of a mouse, or by detecting the user's finger touching the UI element on a touch-screen display of the user device.

The system may capture the user's gesture by capturing the movement of the cursor along the display of the user device or by capturing the movement of the user's finger along the touch-screen display of the user device. For example, the captured user's gesture may include a substantially horizontal, substantially vertical, substantially diagonal, substantially circular clockwise or substantially circular counterclockwise motion of the cursor or the user's finger.

In addition, the user's gesture may include a single touch or a multi-touch gesture. For example, the user's gesture may include placing one finger on the selected UI element and sliding another finger in a substantially horizontal, substantially vertical, substantially diagonal, substantially circular clockwise or substantially circular counterclockwise motion.

The system may calculate a time delay by calculating the time delay as a function of screen coordinates of the cursor or user finger at the start of the gesture and screen coordinates of the cursor or user finger at the end of the gesture. The function may include an algebraic function of a length of a straight line formed by the user's gesture or a transcendental function of a length of circumference of a circle or arc formed by the user's gesture.

Different UI elements may be associated with different tasks, and the system is further configured to determine a task associated with the selected UI element.

In another example aspect, a system for scheduling execution of computer tasks may generate a task scheduling UI operable to receive a UI element from a user via dragging and dropping of the UI element into the task scheduling UI by the user. The system may then identify a computer task associated with the UI element received via the task scheduling UI. The system may then generate a scheduling UI overlay for scheduling a time delay for execution of the computer task. The system may then receive from the user, via the scheduling UI overlay, a time delay for execution of the computer task. The system may then delays execution of the computer task based on the time delay received via the scheduling UI overlay.

The above simplified summary of example aspects serves to provide a basic understanding of the invention. This summary is not an extensive overview of all contemplated aspects, and is intended to neither identify key or critical elements of all aspects nor delineate the scope of any or all aspects of the invention. Its sole purpose is to present one or more aspects in a simplified form as a prelude to the more detailed description of the invention that follows. To the accomplishment of the foregoing, the one or more aspects of the invention include the features described and particularly pointed out in the claims.

### BRIEF DESCRIPTION OF THE DRAWINGS

The accompanying drawings, which are incorporated into and constitute a part of this specification, illustrate one or more example aspects of the invention and, together with the detailed description, serve to explain their principles and implementations.

FIG. 1 is a diagram illustrating an example configuration of a task scheduling system according to one aspect of the invention.

FIGS. 2 and 3 are screen shots illustrating operation of an example task scheduling system according to one aspect of the invention.

FIG. 4 is a flow diagram illustrating an example method for task scheduling according on aspect of the invention.

FIG. 5 is a screen shot illustrating operation of an example task scheduling system according to one aspect of the invention.

FIG. 6 is a flow diagram illustrating another example method for task scheduling according on another aspect of the invention.

FIG. 7 is a diagram illustrating an example general-purpose computer system on which the systems and methods for detection of malicious executable files can be deployed in accordance with aspects of the invention.

### DETAILED DESCRIPTION

Example aspects of the present invention are described herein in the context of systems, methods, computer program products, and graphical user interfaces for gesture-based scheduling of computer tasks. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same items.

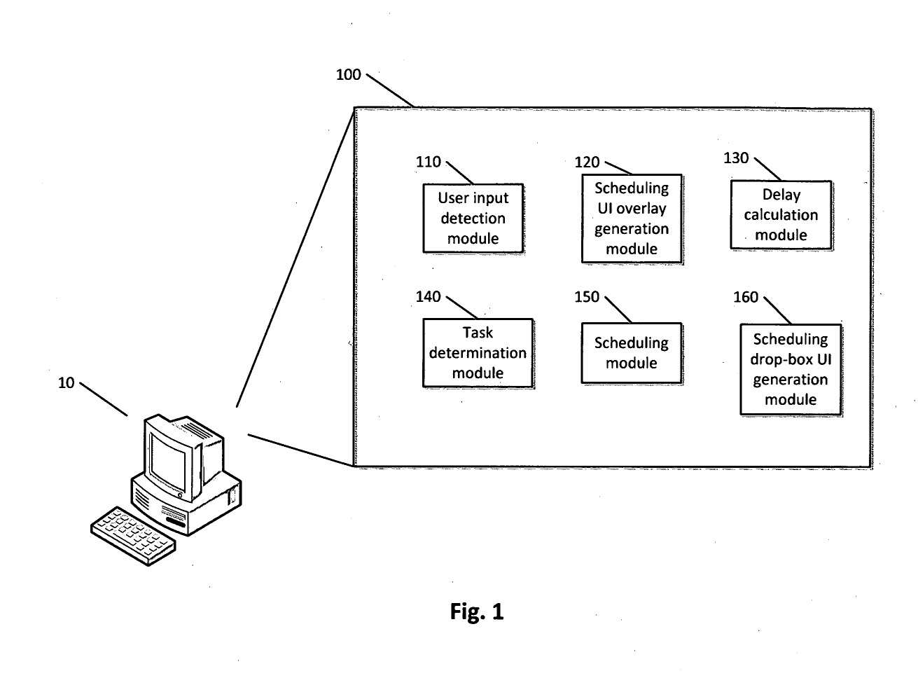

FIG. 1 depicts one example configuration of a system for scheduling execution of computer tasks according to aspects of the invention. In one aspect, the system 100 may be implemented as a software application, a desktop widget, an applet, a script or other type of software program code executable on a computer device 10, such as a PC, tablet, notebook, smart phone or other type of computing devices. As shown, the system 100 may have a plurality of modules, including but not limited to a user input detection module 110, a scheduling UI overlay generation module 120, a delay calculation module 130, a task determination module 140 and a scheduling module 150. In another aspect, the system 100 may also include a scheduling drop-box UI generation module 160.

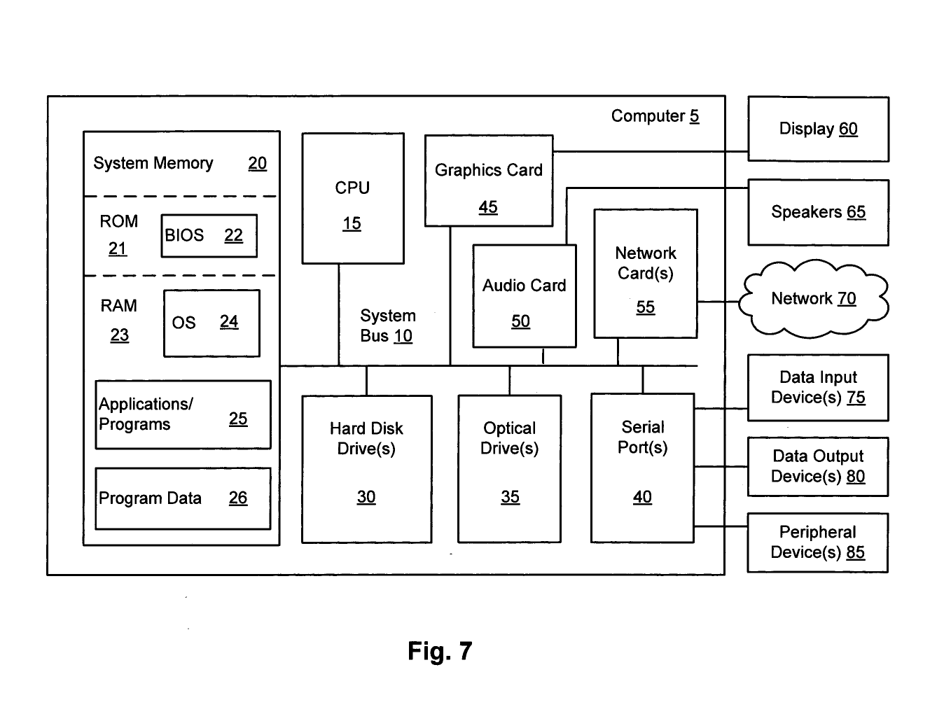

The term “module” as used herein means a real-world device, apparatus, or arrangement of modules implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module can also be implemented as a combination of the two, with certain functions facilitated by hardware alone, and other functions facilitated by a combination of hardware and software. In certain implementations, at least a portion, and in some cases, all, of a module can be executed on the processor of a general purpose computer (such as the one described in greater detail in FIG. 7 below). Accordingly, each module can be realized in a variety of suitable configurations, and should not be limited to any particular implementation exemplified herein.

In the example aspect, the input detection module 110 of the scheduling system 100 is configured to detect a user's selection of a user interface (UI) element on a display of a user device 10, capture a user's gesture following the selection of the UI element, and recognize the captured gesture as an indication of scheduling of a delayed execution of a computer task associated with the selected UI element. For example, to capture the user's input, including user's selection of a UI element and the following user's gesture, the input detection module 110 may first activate an event handler function, which may run as a background process, to capture user input data events, such as mouseover, mousedown and mousemove events, and/or user's finger touches and movement events, in case of touch-screen devices.

When the input detection module 110 detects that a user selected (e.g., clicked with a mouse or touched with a finger) a UI element, such as an e-mail message or a URL of a webpage, the module 110 may use the event handler function to capture the user's gesture and determine if it corresponds to one or more predefined task scheduling gestures. The system 100 may provide and recognize different types of scheduling gestures. For example, clicking on a UI element with a right or left mouse button and moving the mouse pointer in a predetermined motion (e.g., horizontally, vertically, diagonally, circularly clockwise or counterclockwise, etc.) may be recognized as a task scheduling gesture. Touch-screen devices provide opportunity for additional types of gestures including single-touch and multi-touch gestures. For example, the user may place one finger on a selected UI element and then slide the finger across the screen in a predetermined motion (e.g., horizontally, vertically, diagonally, circularly clockwise or counterclockwise, etc.). In another example, the user may place one finger on the selected UI element and slide another finger in a predetermined motion (e.g., horizontally, vertically, diagonally, circularly clockwise or counterclockwise, etc.). The input detection module 110 may recognize only one gesture or multiple different gestures as valid user's gestures for the purpose of scheduling a delayed execution of computer tasks.

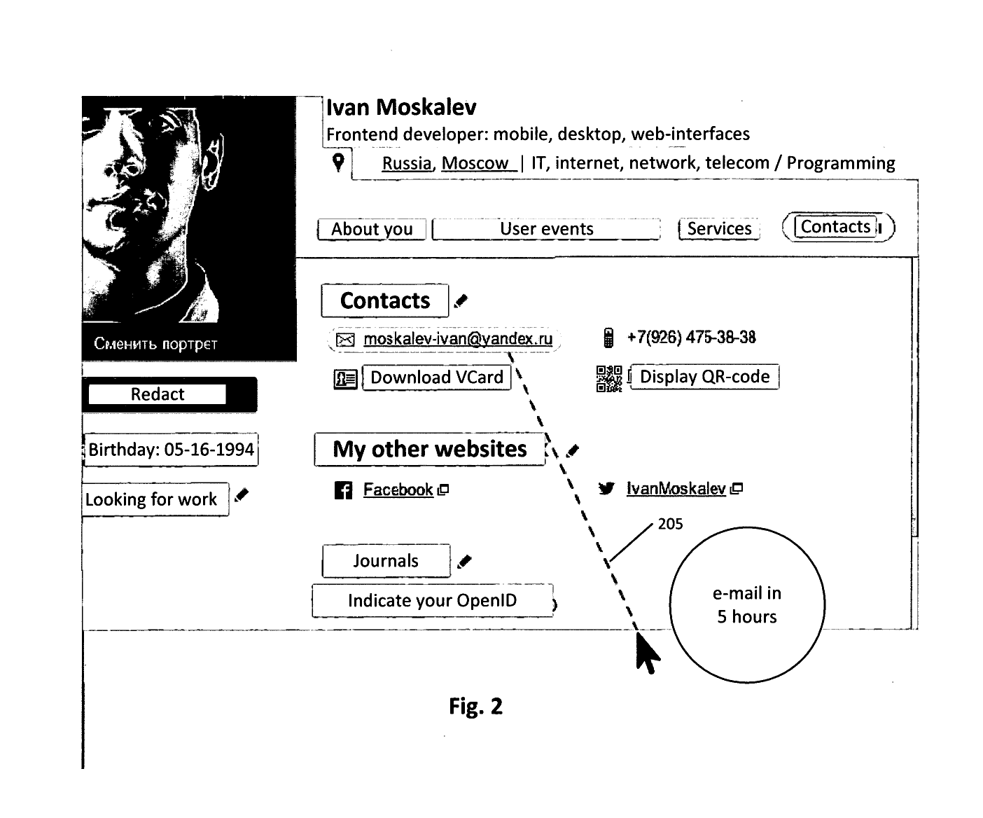

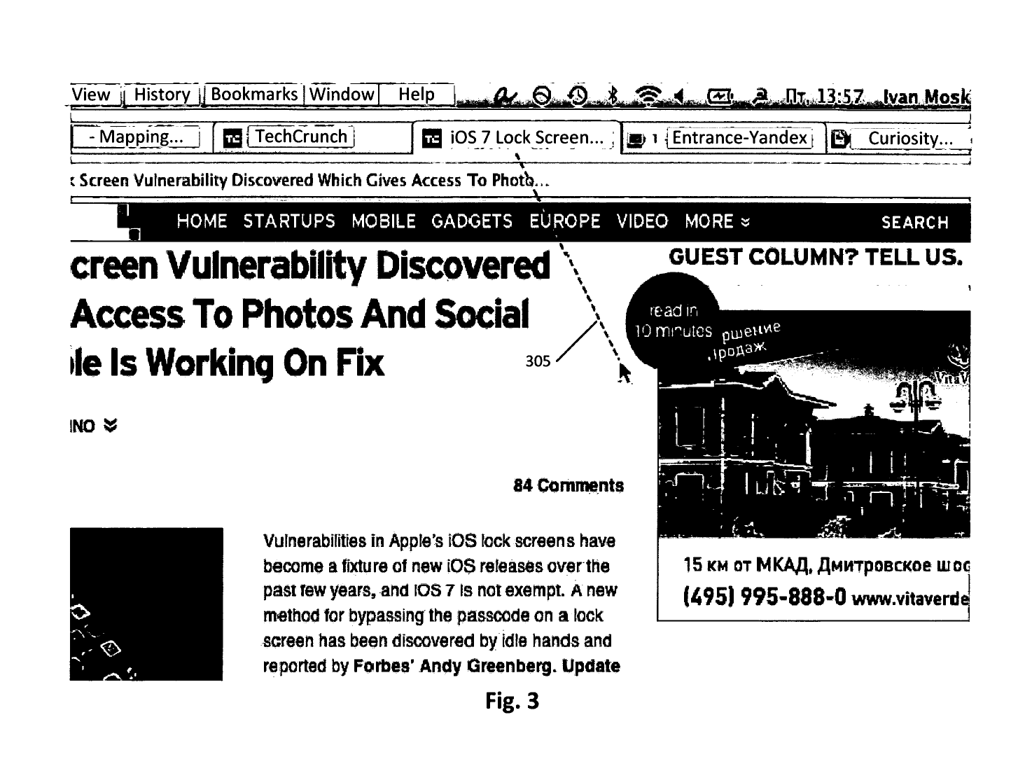

In further aspect, when the input detection module 110 recognizes the user's gesture as one of the predefined task scheduling gestures, the module 110 may pass process to the scheduling UI generation module 120, which is configured to generate scheduling UI overlay graphically indicating duration of a time delay specified via the user's gesture. For example, the scheduling UI overlay may correspond to the user's gesture, such as if user moves a mouse pointer in a straight line, the module 120 may draw a straight prolongation bar, such as bars 205 and 305 shown in FIGS. 2 and 3, respectively, or a timeline bar, indicating the duration of the time delay specified by the user. In another example, if the user's gesture follows a circular motion, the module 120 may draw an analog clock having a minute hand indicating the duration of the time delay specified by the user. Yet in another aspect, the module 120 may generate in addition to the scheduling UI overlay a recognizable feedback, e.g., color change or a shape change, an animation, a sound, a vibration or other visual, audible or tactile feedback.

In further aspect, the scheduling UI overlay may be dynamically modified in real-time with capturing of the user's gesture to indicate the change in duration of the time delay as it is being specified by the user. For example, the described prolongation bar may grow (or shrink) concurrently with the movement of the mouse pointer relative to the original location of the selected UI element, for example as shown in FIG. 2. Similarly, the minute hand of the clock UI overlay discussed above may move clockwise or counterclockwise concurrently with the movement of the mouse pointer. In the example aspect, the scheduling UI overlay may also display a numerical value (e.g., minutes or hours) of the time delay, for example as shown in FIGS. 2 and 3. When task scheduling is completed or abandoned by the user, the scheduling UI overlay may disappear to indicate the end of the task scheduling operation.

In further aspect, when the input detection module 110 recognizes the user's gesture as one of the predefined task scheduling gestures, the module 110 may pass processing to the delay calculation module 130, which is configured to calculate duration of the time delay for execution of a computer task associated with the selected UI element based at least in part on the captured user's gesture. In one aspect, the duration of the time delay may be calculated as a function of the start and end coordinates of the user gesture. For example, when the captured user's gesture is a sliding motion along a straight line via, for example, a prolongation bar 205 shown in FIG. 2, the following algebraic function of a length of a straight line formed by the use's gesture may be used to calculate the time delay:

T=k×\sqrt{(xₑ−xₛ)²+(yₑ−yₛ)²},

where T—is the time delay; k—is a distance-to-time conversion coefficient, which could be based on the screen size or the element size or the UI size or any other parameters; xₑ and Yₑ
coordinates of the location of the mouse pointer at the end of the user's gesture; xₛ and yₛ—coordinates of the location of the mouse pointer at the start of the user's gesture. In another example, when the captured user's gesture is a substantially circular motion via, for example, the analog clock scheduling UI overlay, the time delay T may be calculated as a function of the start and end coordinates of the user's gesture using, e.g., a transcendental function for calculating a length of circumference of a circle or arc formed by the use's gesture. Other functions may be used in different aspects and implementations of the invention.

In further aspect, when the input detection module 110 recognizes the user's gesture as one of the predefined task scheduling gestures, the module 110 may pass processing to the task determination module 140, which is configured to determine what computer task is associated with the selected UI element. In one example aspect, the task determination module 140 may associate only one task with each UI element and schedule that specific task when the user selects the associates UI element. For example, an e-mail UI element may have a send e-mail task; a file UI element may have an open file task; and a web URL UI element may have an open URL task. When the user selects a UI element for scheduling, the module 140 may automatically associate one task with the selected UI element. In another example, a specific task may be associated with a specific function of the selected UI element. For example, a “send” button UI element may have specific sent e-mail task associated therewith.

In further aspect, different tasks may be associated with different UI elements. For example, an e-mail UI element may have an open e-mail task, send e-mail task, print e-mail task, etc.; a file UI element may have an open file task, e-mail file task, print file task, etc.; a web URL UI element may have an open URL task, e-mail URL, etc. To manage different tasks, the task determination module 140 may maintain a data store containing information about a plurality of different programs, associated UI elements and computer tasks associated with each program. When the user selects a UI element for scheduling, the task determination module 140 may generate for the selected UI element a drop down menu that lists associated tasks available for scheduling, so that the user may select which task should be scheduled.

In further aspect, when the task determination module 140 determines the task associated with the selected UI element, the module 140 may pass processing to the scheduling module 150 which is configured to delay execution of the computer task based on the calculated time delay. In one aspect, the scheduling module 150 may place a plurality of delayed computer tasks in a task execution queue and activate a time counter for each delayed task. Each time counter may be set to the duration of the time delay specified by the user. When the time counter for a delayed task reaches zero and stops, the scheduling module 150 may allow execution of the delayed task on the computer system 10. Thus, for example, when the user delays transmission of an e-mail by two hours, the scheduling module 150 will delay transmission of the email by two hours as specified by the user.

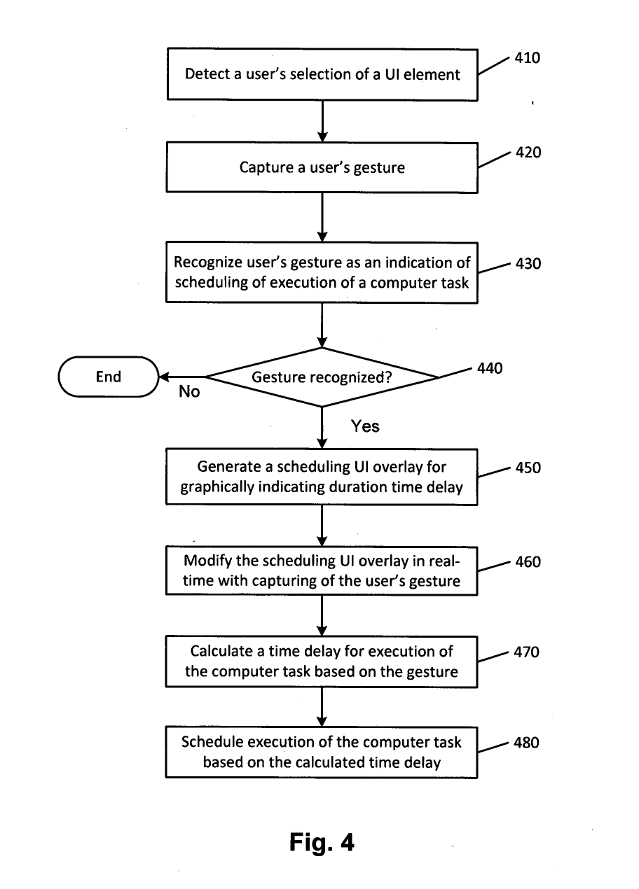

FIG. 4 shows an example of gesture-based task scheduling method according to one aspect of the invention. The method 400 may be implemented by the task scheduling system 100 of FIG. 1. At step 410, the method 400 includes detecting a user's selection of a UI element on a display of a user device 10. At step 420, the method 400 includes capturing a user's gesture following the selection of the UI element. At step 430, the method 400 includes recognizing the user's gesture as an indication of scheduling of execution of a computer task associated with the selected UI element. If the task scheduling gesture recognized at step 440, then at step 450, the method 400 includes generating a scheduling UI overlay for graphically indicating the duration of the time delay. At step 460, the method 400 includes modifying the scheduling UI overlay in real-time with capturing of the user's gesture to indicate a duration of the time delay specified by the user. At step 470, the method 400 includes calculating a time delay for execution of the computer task based on the gesture. At step 480, the method 400 includes scheduling execution of the computer task based on the calculated time delay.

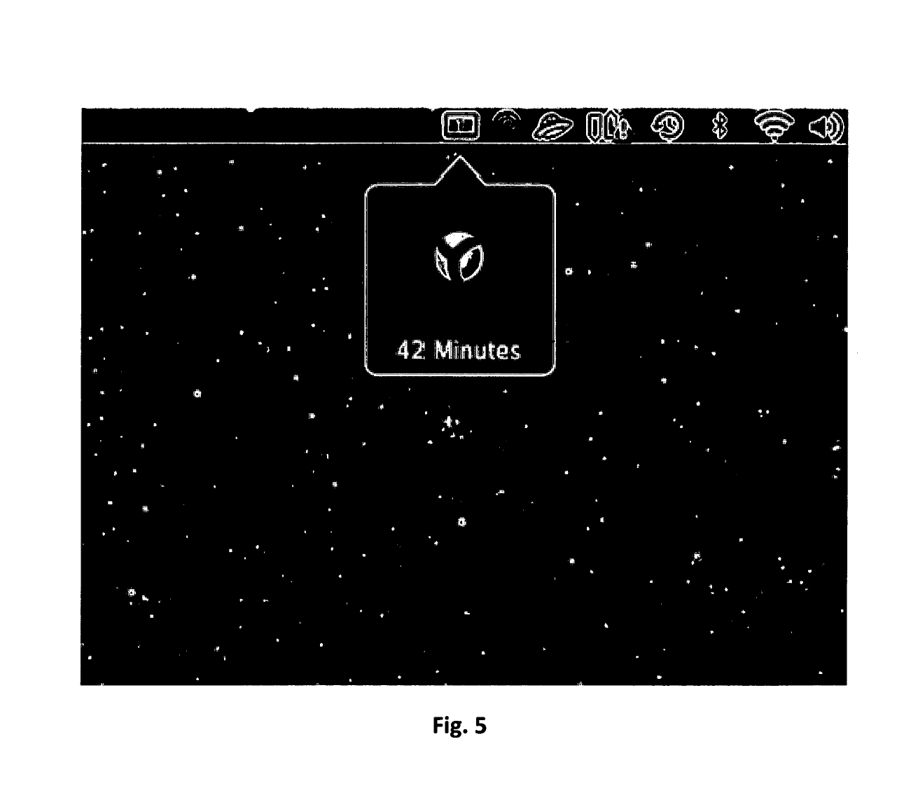

In example aspect, the task scheduling system 100 may be configured to provide a different mechanism for task scheduling via drag-and-drop functionality. Particularly, the system 100 may also include a scheduling drop-box UI generation module 160 that generates a scheduling drop-box UI on a desktop of the computer device 10. A user may select a UI element whose execution task should be delayed and drag and drop the selected UI element into the scheduling drop-box UI. When the user drops the selected UI element into the scheduling drop-box, the module 160 may pass processing to the scheduling UI overlay module 120 that generates a scheduling UI overlay for scheduling execution of the computer task associated with the selected UI element. Examples of scheduling UI overlays are provided above with reference to FIGS. 2 and 3. Thus, elements placed in the scheduling drop-box UI are then scheduled for delayed execution by the scheduling module 150. FIG. 5 illustrates an example scheduling drop-box UI with a Yandex® browser UI element placed therein.

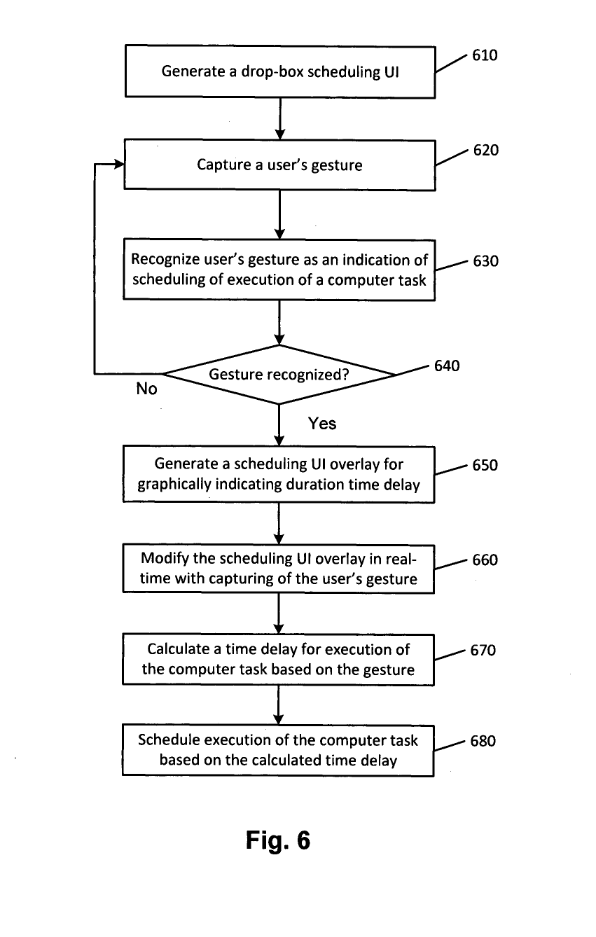

FIG. 6 shows an example of drag-and-drop task scheduling method 600 according to one aspect. The method 600 may be implemented by the task scheduling system 100 of FIG. 1. At step 610, the method 600 includes generating a drop-box scheduling UI operable to receive a UI element from a user via dragging and dropping of the UI element into the drop-box scheduling UI by the user. At step 620, the method 600 includes capturing a user's gesture following the dropping of the UI element. At step 630, the method 400 includes recognizing the user's gesture as an indication of scheduling of execution of a computer task associated with the selected UI element. If the task scheduling gesture recognized at step 640, then at step 650, the method 600 includes generating a scheduling UI overlay for graphically indicating the duration of the time delay. At step 660, the method 600 includes modifying the scheduling UI overlay in real-time with capturing of the user's gesture to indicate a duration of the time delay specified by the user. At step 670, the method 600 includes calculating a time delay for execution of the computer task based on the gesture. At step 680, the method 600 includes scheduling execution of the computer task based on the calculated time delay.

FIG. 7 depicts one example aspect of a computer system 5 that can be used to implement the disclosed systems and methods for gesture-based scheduling of computer tasks. The computer system 5 may include, but not limited to, a personal computer, a notebook, tablet computer, a smart phone, a network server, a router, or other type of processing device. As shown, computer system 5 may include one or more hardware processors 15, memory 20, one or more hard disk drive(s) 30, optical drive(s) 35, serial port(s) 40, graphics card 45, audio card 50 and network card(s) 55 connected by system bus 10. System bus 10 may be any of several types of bus structures including a memory bus or memory controller, a peripheral bus and a local bus using any of a variety of known bus architectures. Processor 15 may include one or more Intel® Core 2 Quad 2.33 GHz processors or other type of microprocessor.

System memory 20 may include a read-only memory (ROM) 21 and random access memory (RAM) 23. Memory 20 may be implemented as in DRAM (dynamic RAM), EPROM, EEPROM, Flash or other type of memory architecture. ROM 21 stores a basic input/output system 22 (BIOS), containing the basic routines that help to transfer information between the modules of computer system 5, such as during start-up. RAM 23 stores operating system 24 (OS), such as Windows® 7 Professional or other type of operating system, that is responsible for management and coordination of processes and allocation and sharing of hardware resources in computer system 5. Memory 20 also stores applications and programs 25. Memory 20 also stores various runtime data 26 used by programs 25.

Computer system 5 may further include hard disk drive(s) 30, such as SATA HDD, and optical disk drive(s) 35 for reading from or writing to a removable optical disk, such as a CD-ROM, DVD-ROM or other optical media. Drives 30 and 35 and their associated computer-readable media provide non-volatile storage of computer readable instructions, data structures, applications and program modules/subroutines that implement algorithms and methods disclosed herein. Although the exemplary computer system 5 employs magnetic and optical disks, it should be appreciated by those skilled in the art that other types of computer readable media that can store data accessible by a computer system 5, such as magnetic cassettes, flash memory cards, digital video disks, RAMs, ROMs, EPROMs and other types of memory may also be used in alternative aspects of the computer system 5.

Computer system 5 further includes a plurality of serial ports 40, such as Universal Serial Bus (USB), for connecting data input device(s) 75, such as keyboard, mouse, touch pad and other. Serial ports 40 may be also be used to connect data output device(s) 80, such as printer, scanner and other, as well as other peripheral device(s) 85, such as external data storage devices and the like. System 5 may also include graphics card 45, such as nVidia® GeForce® GT 240M or other video card, for interfacing with a display 60 or other video reproduction device, such as touch-screen display. System 5 may also include an audio card 50 for reproducing sound via internal or external speakers 65. In addition, system 5 may include network card(s) 55, such as Ethernet, WiFi, GSM, Bluetooth or other wired, wireless, or cellular network interface for connecting computer system 5 to network 70, such as the Internet.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In the interest of clarity, not all of the routine features of the aspects are disclosed herein. It will be appreciated that in the development of any actual implementation of the invention, numerous implementation-specific decisions must be made in order to achieve the developer's specific goals, and that these specific goals will vary for different implementations and different developers. It will be appreciated that such a development effort might be complex and time-consuming, but would nevertheless be a routine undertaking of engineering for those of ordinary skill in the art having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for scheduling execution of computer tasks, the method comprising:
detecting, by a processor of a user device, a user's selection of a user interface (UI) element on a display of the user device;
capturing a user's gesture following the selection of the UI element;
recognizing the user's gesture as an indication of scheduling of a delayed execution of a computer task associated with the selected UI element;
calculating a time delay for execution of the computer task based on the gesture; and
scheduling a delayed execution of the computer task based on the calculated time delay.

2. The method of claim 1, wherein detecting the user's selection of the UI element further includes:
generating a scheduling UI overlay graphically indicating a duration of the time delay; and
modifying the scheduling UI overlay in real-time with capturing of the user's gesture to graphically indicate the duration of the time delay specified by the user.

3. The method of claim 2, wherein the scheduling UI overlay includes one of a straight prolongation bar, a time line and an analog clock.

4. The method of claim 3, wherein detecting the user's selection the UI element includes one of:
detecting positioning of a cursor over the UI element and right- or left-clicking of a mouse; and
detecting a user's finger touching the UI element on a touch-screen display of the user device.

5. The method of claim 4, wherein capturing the user's gesture includes one of:
capturing the movement of the cursor along the display of the user device; and
capturing the movement of the user's finger along the display of the user device.

6. The method of claim 5, wherein the captured user's gesture includes one of a substantially horizontal, substantially vertical, substantially diagonal, substantially circular clockwise and substantially circular counter-clockwise motion of the cursor or the user's finger.

7. The method of claim 5, wherein calculating the time delay further includes:
calculating the time delay as a function of screen coordinates of the cursor or user's finger at the start of the gesture and screen coordinates of the cursor or user's finger at the end of the gesture.

8. The method of claim 7, wherein the function includes one of an algebraic function of a length of a straight line formed by the user's gesture and a transcendental function of a length of circumference of a circle or arc formed by the user's gesture.

9. The method of claim 1, wherein different tasks are associated with different UI elements, and detecting the user's selection of the UI element further includes one of:
determining at least one computer task associated with the selected UI element; and
determining a computer task associated with function of the selected UI element.

10. The method of claim 1, wherein the user's gesture includes a single-touch or a multi-touch gesture.

11. The method of claim 10, wherein the user's gesture includes placing one finger on the selected UI element and sliding another finger in one of a substantially horizontal, substantially vertical, substantially diagonal, substantially circular clockwise and substantially circular counter-clockwise motion.

12. A system for scheduling execution of computer tasks, the system comprising:
a memory storing a plurality of software modules, including at least:
an input detection module configured to:
detect a user's selection of a user interface (UI) element on a display of a user device;
capture a user's gesture following the selection of the UI element; and
recognize the captured gesture as an indication of scheduling of a delayed execution of a computer task associated with the selected UI element;
a delay calculation module configured to calculate a time delay for execution of the computer task based on the captured gesture; and
a scheduling module configured to schedule a delayed execution of the computer task based on the calculated time delay; and
a processor coupled to the memory, the processor configured to execute the plurality of software modules.

13. The system of claim 12 further comprising a scheduling UI overlay generation module configured to:
generate the scheduling UI overlay for graphically indicating the duration of the time delay; and
modify the scheduling UI overlay in real-time with capturing of the user's gesture to graphically indicate the duration of the time delay.

14. The system of claim 13, wherein the scheduling UI overlay includes one of a straight prolongation bar, a time line and an analog clock.

15. The system of claim 12, wherein the input detection module further configured to:
detect positioning of a cursor over the UI element and right- or left-clicking of a mouse; and
detect the user's finger touching the UI element on a touch-screen display of the user device.

16. The system of claim 15, wherein the input detection module further configured to: capture the movement of the cursor along the display of the user device; and
capture the movement of the user's finger along the display of the user device.

17. The system of claim 16, wherein the captured user's gesture includes one of a substantially horizontal, substantially vertical, substantially diagonal, substantially circular clockwise and substantially circular counter-clockwise motion of the cursor or the user's finger.

18. The system of claim 16, wherein the delay calculation module further configure to:
calculate the time delay as a function of screen coordinates of the cursor or user finger at the start of the gesture and screen coordinates of the cursor or user finger at the end of the gesture.

19. The system of claim 18, wherein the function includes one of an algebraic function of a length of a straight line formed by the user's gesture and a transcendental function of a length of circumference of a circle or arc formed by the user's gesture.

20. The system of claim 12 further comprising a task determination module configured to:
maintain a data store containing information about a plurality of different programs, UI elements associated with each program and tasks associated with each program; and
determine at least one computer task associated with the selected UI element or function of the selected UI element.

21. The system of claim 12, wherein the scheduling module further configured to:
place a plurality of delayed computer tasks in a task execution queue;
activate a time counter for each delayed task; and
when the time counter stops, allow execution of the delayed task.

22-28. (canceled)
